(19) United States
(12) Patent Application Publication
(10) Pub. No.: US 2020/0290747 A1
(43) Pub. Date: Sep. 17, 2020

(54) AIRCRAFT NACELLE

(71) Applicant: Safran Nacelles, GONFREVILLE L'ORCHER (FR)

(72) Inventors: David DELSOL, MOISSY CRAMAYEL (FR); Sabrina KERKABOU, MOISSY CRAMAYEL (FR); Ali KHEZZAR, MOISSY CRAMAYEL (FR)

(73) Assignee: Safran Nacelles, GONFREVILLE L'ORCHER (FR)

(21) Appl. No.: 16/889,197

(22) Filed: Jun. 1, 2020

Related U.S. Application Data
(63) Continuation of application No. PCT/FR2018/053041, filed on Nov. 29, 2018.

(30) Foreign Application Priority Data
Nov. 30, 2017 (FR) 1761472

(51) Int. Cl. B64D 33/02; B64C 3/26; B64D 29/02

(52) U.S. Cl. CPC B64D 33/02; B64D 29/02; B64C 3/26

(57) ABSTRACT

An aircraft nacelle includes a front portion having an inner wall and an outer wall joined by an annular front frame to delimit a gas passage flow path, the front frame being formed by a plurality of adjacent sheet metal frames which are joined together over at least a portion of the periphery thereof.

### CROSS-REFERENCE TO RELATED APPLICATIONS

This application is a continuation of International Application No. PCT/FR2018/053041, filed on Nov. 29, 2018, which claims priority to and the benefit of FR 17/61472 filed on Nov. 30, 2017. The disclosures of the above applications are incorporated herein by reference.

### FIELD

The present disclosure relates to an aircraft nacelle having a front portion including an inner wall and an outer wall joined by an annular front frame to delimit a gas passage flow path.

### BACKGROUND

The statements in this section merely provide background information related to the present disclosure and may not constitute prior art.

It is known that an aircraft equipped with propulsion units comprising motors such as turbojet engines includes a tubular nacelle surrounding each of the turbojet engines so as to delimit a gas passage flow path to supply a fan of the turbojet engine.

Each nacelle includes a front portion including an inner wall and an outer wall joined by an annular front frame to delimit the gas passage flow path. The front frame supports a defrosting lip and should have an appropriate structure to resist the impact of a bird on the front portion, or of any other obstacle in the air.

In a context of improving safety, it is constantly sought to increase the resistance to the impact of a bird. For this purpose, it has been considered to increase the thickness of the lip, however this solution increases the weight of the lip and the amount of energy required to deform the lip.

It has also been considered to increase the thickness of the front frame, however this solution implies a substantial increase in the weight of the front portion to offer satisfactory robustness.

### SUMMARY

This section provides a general summary of the disclosure and is not a comprehensive disclosure of its full scope or all of its features.

The present disclosure increases the impact resistance of the front portion without a substantial increase in weight of the nacelle.

The present disclosure provides an aircraft nacelle having a front portion including an inner wall and an outer wall joined by an annular front frame to delimit a gas passage flow path, in which the front frame is formed of several adjacent sheet metal frames joined to each other on at least one portion of the periphery thereof.

Thus, in comparison with equal weight sheet metals having a total thickness equal to the thickness of the front frame existing before the present disclosure, a substantial increase in the impact resistance has been observed. In other words, the front frame according to the present disclosure offers an improved resistance compared to an increase in the thickness of said front frame. It is thus possible to obtain a front frame with a reduced weight relative to a solution consisting in increasing the thickness of the frame, this with an equivalent resistance.

Moreover, this has in particular been confirmed in tests by studying the frequency and time responses to dynamic loads after modeling. It has thus been noted that several absorption systems placed in series, for example two, with a predetermined stiffness coefficient k offered a much greater impact resistance than a single absorption system with a stiffness coefficient K corresponding, for comparison, to a multiple of the stiffness coefficient k compared to the number of absorption systems placed in series (K=n·k) to be compared, for example the double.

Each adjacent sheet metal frame is arranged to connect the inner wall to the outer wall.

Thus, each adjacent sheet metal frame has an end arranged to be connected to the inner wall and an opposite end arranged to be connected to the outer wall.

In one form, the connection between each adjacent sheet metal frame and the inner and outer walls is performed via elements such as inner and outer angles respectively.

According to an advantageous version of the present disclosure, the front frame includes two joined sheet metal frames, namely a first sheet metal frame and a last sheet metal frame. An increase in the impact resistance is thus obtained through a small increase in the complexity of the structure of the front frame.

In one form, the first sheet metal frame has a greater breaking stress, but a lower breaking elongation than the last sheet metal frame.

In another form, and in a particular configuration, the first sheet metal frame is made of Ti-6Al-4V titanium and the last sheet metal frame is made of T60 grade titanium material. Of course, other materials and thicknesses can be used such that the first sheet metal frame has a greater breaking stress, but a lower breaking elongation than the last sheet metal frame.

According to another advantageous aspect of the present disclosure, the sheet metal frames are adjoined on at least one portion of the surface thereof. A maintenance of the compactness of the front frame is thus ensured.

According to yet another aspect of the present disclosure, the front frame includes a frustoconical inner portion and a frustoconical outer portion connected by a middle portion having a curvilinear profile, and the sheet metal frames are adjoined in the frustoconical portions and are spaced apart in the middle portion with a curvilinear profile. Thus, during an impact on the front frame leading to the break of one of the two sheet metals, the second sheet metal retains its integrity and its ability to absorb a new impact.

According to yet other aspects of the present disclosure taken alone or in combination:

The nacelle includes an inner connecting angle of the front frame with the inner wall and an outer connecting angle of the front frame with the outer wall, and at least one of the connecting angles includes several adjoined pieces of sheet metal. For example, the inner connecting angle includes several adjoined sheet metal pieces while the outer connecting angle is formed of a single sheet metal piece. Thus, by an appropriate choice of the portions including a single sheet metal piece or several adjoined sheet metal pieces it is possible to anticipate a point of failure, and therefore to control the break chronology/sequence.

The nacelle includes an annular lip extending upstream of the front frame by reference to a direction of flow in the gas flow path, and the annular lip is fastened to the front frame by lip connecting angles.

The lip connecting angles are common with the corresponding inner connecting angle or outer connecting angle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic perspective view of a nacelle front portion according to the present disclosure;

FIG. 2 is an enlarged schematic cross-sectional view according to the plane II of FIG. 1;

FIG. 3 is an enlarged view of detail III of FIG. 2; and

FIG. 4 is an enlarged view of detail IV of FIG. 2.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

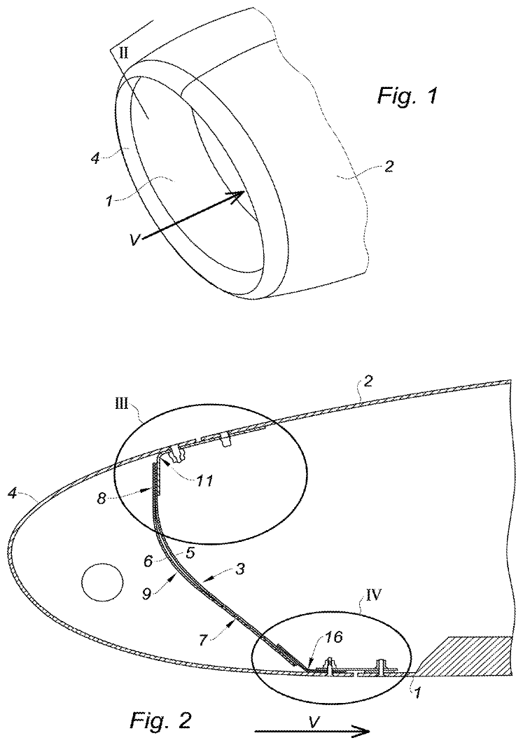

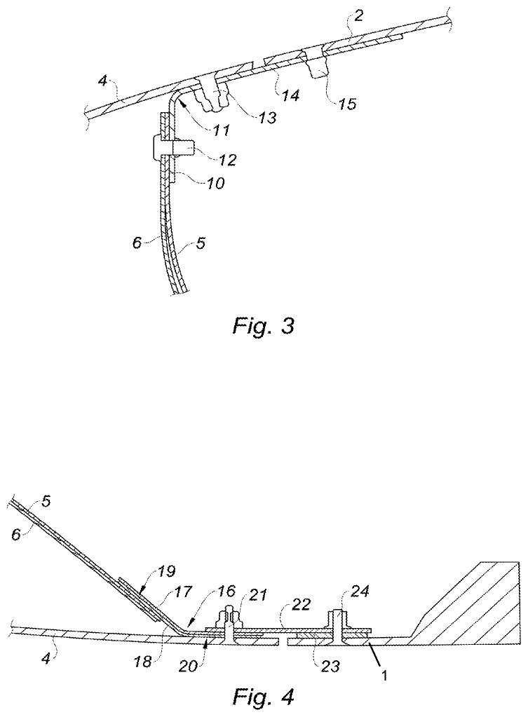

With reference to FIGS. 1 through 4, the front portion of the illustrated nacelle includes, in a manner known per se, an annular inner wall 1 and an annular outer wall 2 joined by a front frame 3 to delimit a gas passage flow path V.

In the following description, the terms “inner” and “outer” are used with reference to a radial direction of the nacelle. Also, in a manner known per se, the front portion comprises an annular lip 4 sealingly fastened to the front frame 3.

According to the present disclosure, the front frame includes a plurality of adjacent sheet metal frames, which in this form includes a first sheet metal frame 6 and a second sheet metal frame 5 joined to each other along the periphery thereof. In the illustrated example, the two sheet metal frames 5 and 6 are made of Ti-6Al-4V titanium. The first sheet metal frame 6 can be made according to different configurations in order to improve the capacities of each frame related to the load. For example, the first sheet metal frame 6 can be made of a material with a high breaking stress, but a limited breaking elongation (for example Ti-6Al-4V) to absorb increased energy from the obstacle such as a bird strike before breaking, while the second sheet metal frame 5 is made of a material with a high breaking elongation (for example T60 grade titanium material) to allow a significant plastic deformation providing a retention of the bird.

In the illustrated example, the front frame 3 includes a frustoconical inner portion 7 and a frustoconical outer portion 8 connected by a middle portion 9 having a curvilinear profile.

In the frustoconical portions, the first sheet metal frame 6 and the second sheet metal frame 5 are adjoined while, in the middle portion having a curvilinear profile, the first sheet metal frame 6 and the second sheet metal frame 5 are spaced from each other by a distance just sufficient to allow an assembly of the first sheet metal frame 6 and the second sheet metal frame 5 without prestressing. In practice, the spacing between the first sheet metal frame 6 and the second sheet metal frame 5 in the middle portion 9 is on the order of manufacturing tolerances of shaping the first sheet metal frame 6 and the second sheet metal frame 5, which in one form is a few tenths of a millimeter.

On the outer side, the first sheet metal frame 6 and the second sheet metal frame 5 are connected to each other and to a first wing/flange 10 of a V-shaped outer connecting angle 11 by rivets 12. The outer connecting angle 11 is formed of a single sheet metal piece and includes a second wing/flange 14 to which, on the one hand, the annular lip 4 is fastened by rivets 13, and on the other hand, the outer wall 2 is fastened by rivets 15. It should be understood, however, that the outer connecting angle 11 may be formed of a plurality of sheet metal pieces.

On the inner side, the first sheet metal frame 6 and the second sheet metal frame 5 are glued/bonded to each other, and to a first wing/flange 19 of a V-shaped inner connecting angle 16 which includes two sheet metal pieces 17 and 18 glued/bonded to each other (also referred to as “lip connecting angles”). These lip connecting angles 17/18 may also be employed as an outer connecting angle while remaining within the scope of the present disclosure. The V-shaped inner connecting angle 16 includes a second wing/flange 20 which is fastened to the annular lip 4 by rivets 21, and to the wall 1 by an annular sheet metal piece 22 forming a strut between the second wing/flange 20 to which it is fastened by the rivets 21, and the wall 1 to which it is fastened by rivets 24 by bearing on a shim 23.

Of course, the present disclosure is not limited to the described form and is capable of variants without departing from the scope of the present disclosure as defined by the claims.

In particular, although the nacelle, according to the present disclosure, has been described in relation to a front frame including only two associated sheet metal frames, it is possible to carry out the present disclosure with a front frame including three associated sheet metal frames or even more if desired to obtain a front frame having a particularly high impact resistance while reducing the additional sheet metal weight involved to obtain it.

Although the present disclosure has been described in relation to a form comprising an outer angle including a single sheet metal piece, it can be carried out with an angle including several adjoined pieces of sheet metal.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An aircraft nacelle comprising a front portion including an inner wall and an outer wall joined by an annular front frame to delimit a gas passage flow path, wherein the annular front frame is formed by a plurality of adjacent sheet metal frames joined to each other on at least one portion of a periphery thereof.

2. The nacelle according to claim 1, wherein the annular front frame includes two adjacent sheet metal frames joined to each other, the two adjacent sheet metal frames including a first sheet metal frame and a second sheet metal frame.

3. The nacelle according to claim 1, wherein the plurality of sheet metal frames include a first sheet metal frame and a second sheet metal frame, wherein the first sheet metal frame has a greater breaking stress and a lower breaking elongation than the second sheet metal frame.

4. The nacelle according to claim 3, wherein the first sheet metal frame is made of Ti-6Al-4V titanium material and the second sheet metal frame is made of T60 grade titanium material.

5. The nacelle according to claim 1, wherein the plurality of adjacent sheet metal frames are adjoined on at least one portion of a surface thereof.

6. The nacelle according to claim 1, wherein the front frame includes a frustoconical inner portion and a frustoconical outer portion, the frustoconical inner portion and the frustoconical outer portion being connected by a middle portion having a curvilinear profile, wherein the plurality of adjacent sheet metal frames are adjoined in the frustoconical inner portion and frustoconical outer portion, and are spaced apart in the middle portion with the curvilinear profile.

7. The nacelle according to claim 1 further comprising an inner connecting angle connecting the front frame with the inner wall and an outer connecting angle connecting the front frame with the outer wall, wherein at least one of the inner connecting angle and the outer connecting angle includes a plurality of sheet metal pieces.

8. The nacelle according to claim 7, wherein the inner connecting angle includes a plurality of sheet metal pieces and the outer connecting angle is formed of a single sheet metal piece.

9. The nacelle according to claim 1 further comprising an annular lip extending upstream of the front frame in reference to a direction of flow in the gas passage flow path, wherein the annular lip is fastened to the front frame by lip connecting angles.

10. The nacelle according to claim 9, wherein the lip connecting angles are common with a corresponding inner connecting angle or an outer connecting angle.
